(19) United States
(12) Patent Application Publication
(10) Pub. No.: US 2024/0375851 A1
(43) Pub. Date: Nov. 14, 2024

(54) A SACHET DISPENSER

(71) Applicant: Optimal Vision Plus Pty Ltd, Osborne Park, Western Australia (AU)

(72) Inventors: Gary GASCOIGNE, Osborne Park, Western Australia (AU); Robert Allen, Osborne Park, Western Australia (AU)

(73) Assignee: Optimal Vision Plus Pty Ltd, Osborne Park, Western Australia (AU)

(21) Appl. No.: 18/580,380

(22) PCT Filed: Jun. 16, 2022
(86) PCT No.: PCT/AU2022/050596

§ 371 Date: Jan. 18, 2024

(30) Foreign Application Priority Data
Jul. 19, 2021 (AU) 2021902208

(51) Int. Cl. B65D 83/08

(52) U.S. Cl. CPC B65D 83/0835; B65D 2583/082

(57) ABSTRACT

The present disclosure provides a sachet dispenser for dispensing sachets of tablets, pills, capsules or another suitable form of medication or supplement. The sachet dispenser has a body which forms a cavity for receiving a roll of sachets. The body has a positioned for throughput of sachets of the roll of sachets. The roll of the sachets rotates within the cavity when a sachet is pulled through the slot out of the body. The sachet dispenser has first and second support surfaces on the body facing away from the body for supporting the sachet on the body after the sachet has been pulled through the slot and out of the body. The first and second support surfaces are positioned adjacent and along the slot such that the slot is located between the first and second support surfaces. Dependent on an orientation of the sachet dispenser relative to a direction of gravity, the sachet when pulled through the slot, the sachet is supportable by the first support surface or substantially equally supportable by the second support surface and either a first side or an opposite second side of the sachet faces away from the body.

### FIELD OF THE INVENTION

The present disclosure relates to a sachet dispenser and relates particularly to a sachet dispenser for dispensing sachets of medicine.

Throughout this specification the terms “medicine” and “medicines” are used for medication or supplements or the like provided in the form of tablets, pills, capsules or another suitable form.

### BACKGROUND OF THE INVENTION

A large number of people require medicine administered daily or multiple times each day. Further, supplements are often being consumed on a regular basis. The manual selection of medicines and supplements is cumbersome and it is also possible that mistakes can be made, which in case of critical medication can have serious consequences.

It is known to arrange dosages of the tables or pills in blister packs, such as Webster packs, which have compartments for a selection of the tablets or pills with labels identifying the content, a person, a date and possibly a day of the week or time of a day (for example, if a person has to take tablets or pills multiple times each day). A user or staff member in a hospital, nursing home or the like may then simply identify a label on a compartment of the Webster pack, which contains the required selection of tablets or pills.

Alternatively, sachets containing the tablets or pills may be used. The sachets may be provided in the form of a roll of the sachets and each sachet may contain a daily dose of the tablets or pills for a person or a dose of the tablets or pills that a person may have to take multiple times each day. Each sachet has a label for identifying the person, the content a date and possible including other information. Such a roll of sachets is usually packaged in a card board box and delivered to a user, hospital or a nursing home or the like where it is unpacked and then loaded into a dispenser. The dispenser is operated by pulling a sachet through a slot of the dispenser and then separating the sachet from the roll of the sachets. However, known dispensers have disadvantages as it is often difficult to identify the label on the sachet. The label is positioned either on a first side or an opposite second side of the sachet (facing towards or away from the roll of the sachets), which dependents on a preference of a supplier. If the sachet is dispensed from the dispenser (pulled out of the dispenser), either the front side of the dispensed sachet is facing away from the dispenser or the rear side is facing away from the dispenser. It is consequently possible that the label is facing towards the dispenser which makes it difficult to identify the label.

The present disclosure provides technological advancement.

### SUMMARY OF THE INVENTION

The present invention provides in a first aspect a sachet dispenser for dispensing sachets of medicine, the sachet dispenser comprising:
a body forming a cavity for receiving a roll of sachets;
a slot within the body, the slot being positioned for throughput of sachets of the roll of sachets, wherein the roll of the sachets rotates within the cavity when a sachet is pulled through the slot out of the body; and
first and second support surfaces on the body facing away from the body for supporting the sachet after the sachet has been pulled through the slot, the first and second support surfaces being positioned adjacent and along the slot such that the slot is located between the first and second support surfaces;
wherein, dependent on an orientation of the sachet dispenser relative to a direction of gravity, the sachet, when pulled through the slot, is supportable by the first support surface or substantially equally supportable by the second support surface and either a first side or an opposite second side of the sachet faces away from the body.

The dispenser can be used such that, chosen by a user, a sachet that was pulled through the slot out of the body is supported by either the first support surface or the second support surface whereby either the first or the opposite second side of the sachet is exposed. As a label identifying a content of the sachet or including further relevant information (such as a day of the week and/or time of a day and/or name of a person) is located either on the first side or on the opposite second side of the sachet, it is possible for the user to use the dispenser and choose a support surface such that a label is facing away from the body of the dispenser and can be conveniently identified, which improves not only the convenience of usage, but also the safety.

The first and second support surface may be of any suitable shape, such as planar or curved. Further, the first and second support surfaces may be located on a common plane that may be planar or curved. The first and second support surfaces may be located immediately adjacent the slot. Further, the first and second support surfaces may have substantially the same extension and shape.

In one specific embodiment the first and second support surfaces are located on a concavely curved common plane.

The body may have an axis which may coincide with an axis of the roll of the sachets when positioned within the body and the slot may also have an axis. The first and second support surfaces may be symmetrical relative to a plane of symmetry defined by the axis of the body and an axis of the slot.

The body may comprise clips at the first and second support surfaces arranged to secure the sachet on either the first or the second support surface.

The body may comprise rounded portions and may be formed from a polymeric material, such as a suitable plastics material. The body may be at least partially transparent such that convenient inspection of the roll of the sachets from an outside of the body is possible in order to decide when reloading of the sachet dispenser will be required.

The body may comprise two halves, which may be separable to load a roll of the sachets and which may comprise a snap-fit arranged to engage the two halves to each other such that the body is closed.

The body may be arranged for mounting a wall, such as a vertical wall of a building or structure. The body may have a base portion positioned opposite the first and second support surfaces which are separated by the slot. The base portion maybe arranged for mounting on the wall of a building or structure whereby the first and second support surfaces face away from the wall of the building or structure when the dispenser is mounted on the wall of the building or structure.

The invention will be more fully understood from the following description of specific embodiments of the invention. The description is provided with reference to the accompanying drawings.

### BRIEF DESCRIPTION OF THE DRAWINGS

FIG. 1 is a perspective view of a sachet dispenser in accordance with an embodiment of the present invention;

FIGS. 2 and 3 are cross-sectional side views of the sachet dispenser in accordance with the embodiment of the present invention;

FIG. 4 is top view of the sachet dispenser in accordance with the embodiment of the present invention; and

FIG. 5 is bottom view of the sachet dispenser in accordance with the embodiment of the present invention.

### DETAILED DESCRIPTION OF EMBODIMENTS

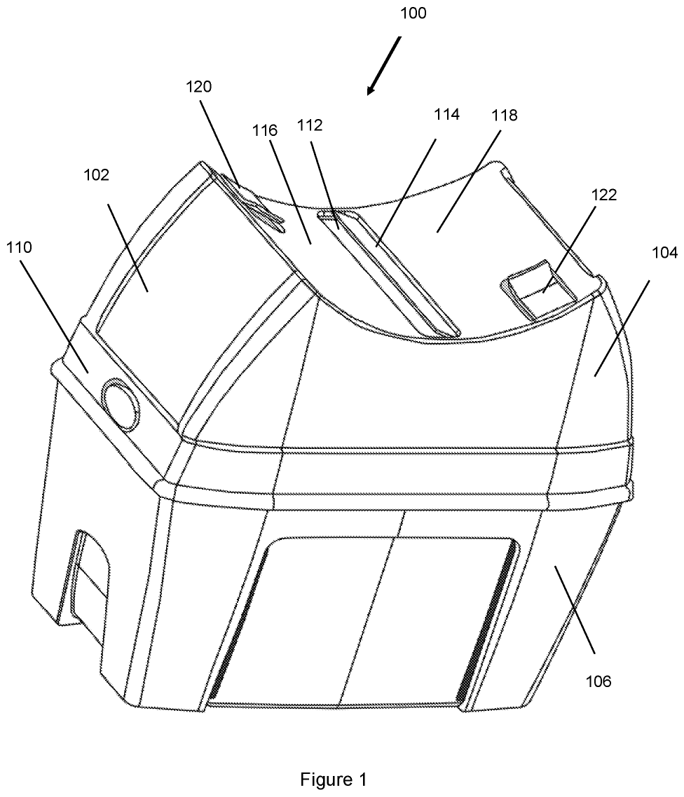

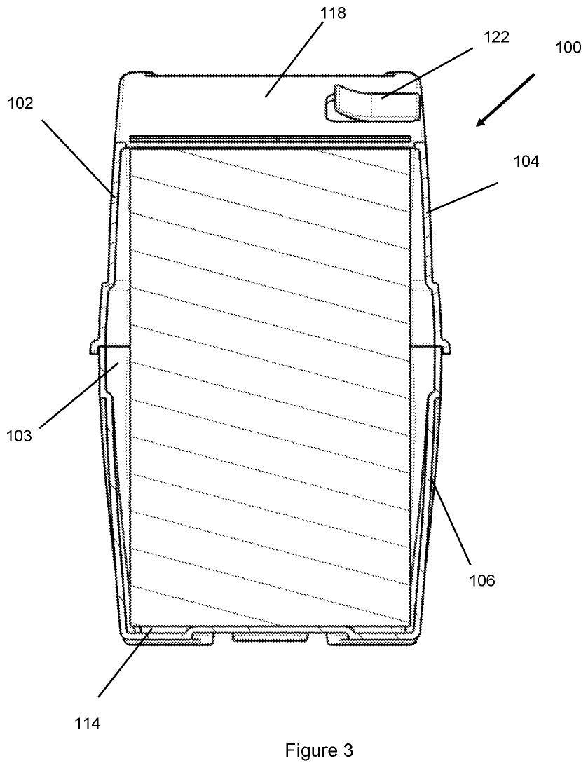

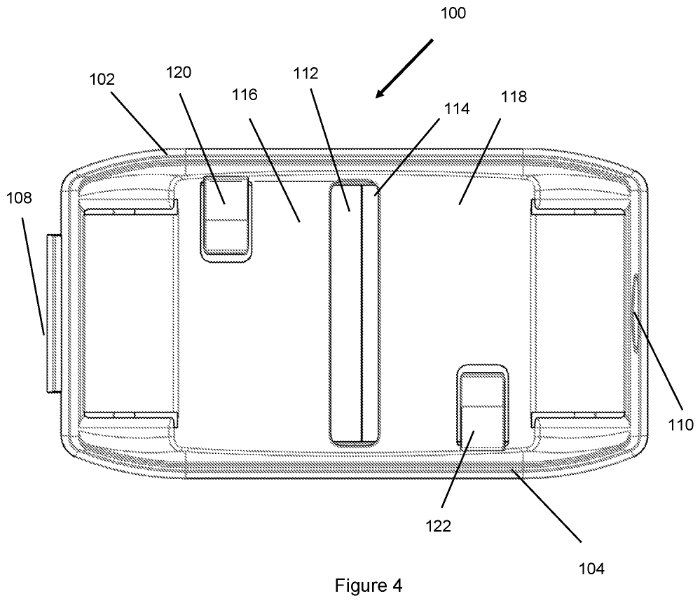

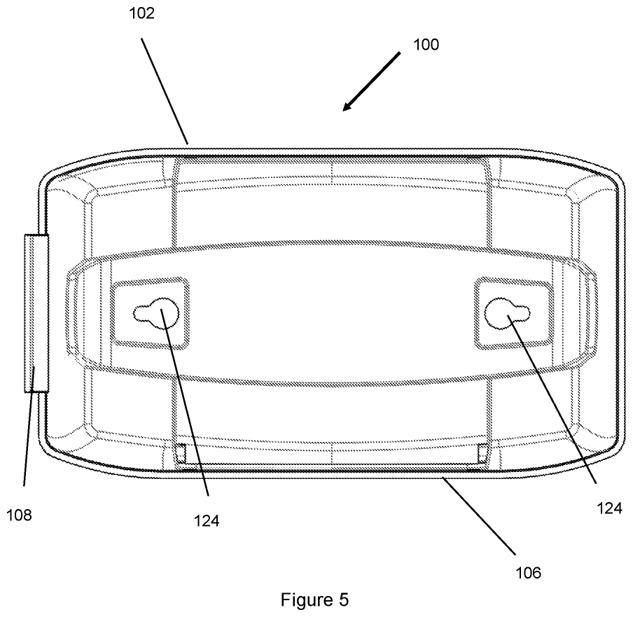

Referring to FIGS. 1-5, a sachet dispenser 100 in accordance with an embodiment of the present invention is now described. The sachet dispenser 100 has a body 102 with an interior cavity 103 arranged to receive a roll of sachets containing medicines (not shown). The body 102 is formed from two halves 104 and 106, which are separable whereby the body 102 can be opened to receive the roll of the sachet 114. The halves 104, 106 are coupled by a hinge 108 and a snap-fit arrangement 110 is used to secure the halves 104 and 106 such that the body 102 is in a closed condition.

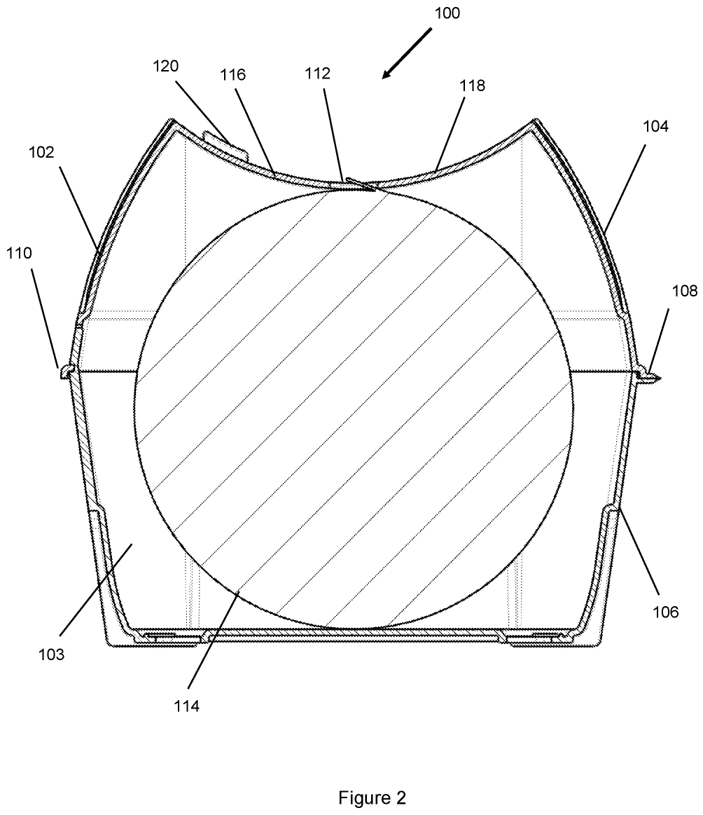

The body 102 has a slot 112 through which the sachets 114 can be pulled out of the body 102. An end of a sachet 114 is schematically indicated in FIGS. 1,2 and 4 and a schematic cross-sectional view of the roll of the sachets 114 is shown in FIG. 2. The sachet dispenser 100 has two support surfaces 116 and 118, which are located at opposite sides of the slot 112. When a sachet is fully pulled out of the slot 112, the sachet 114 can rest (be supported) by either the support surface 116 or the support surface 118 (dependent on an orientation of the sachet dispenser relative to a direction of gravity).

In the illustrated embodiment the support surfaces 116 and 118 are located immediately adjacent the slot 112 and are positioned on a common plane which is concavely curved. In variations of the illustrated embodiment the support surfaces 116 and 118 may for example be on a flat plane or may be positioned on different planes. Further, the support surfaces 116 and 118 may alternatively not be positioned immediately adjacent the slot 112.

The body 102 further comprises clips 120 and 122 which are positioned at the support surfaces 116 and 118 and arranged to secure the sachet 114 on either the support surface 116 or the support surface 118 once the sachet has been pulled out of the slot 112. In addition, the body 102 has bores 124, which can be used to secure the sachet dispenser 100 on a wall, such as a vertical or a horizontal wall, using suitable screws or bolts.

The body 102 may be formed form a suitable polymeric material, such as a plastics material. The body 102 may at least be partially transparent. In this embodiment the body 102 has substantially straight and rounded wall portions. A person skilled in the art will appreciate that alternatively the body may have a different shape, such as a generally cylindrical shape.

Further, a person skilled in the art will appreciate that the dispenser may not only be suitable for dispensing sachets of tablets, pills or capsules, but may also be suitable for dispensing sachets containing medication or vitamins or the like provided in another suitable form, such as in the form of a powder or a liquid.

1.-11. (canceled)

12. A medicine dispenser dispensing sachets of medicine, the medicine dispenser comprising:
a body forming a cavity for receiving a roll of sachets;
a slot within the body, the slot being positioned for throughput of sachets of the roll of sachets, wherein the roll of the sachets rotates within the cavity when a sachet is pulled through the slot out of the body; and
first and second support surfaces on the body facing away from the body for supporting the sachet after the sachet has been pulled through the slot, the first and second support surfaces being positioned adjacent and along the slot such that the slot is located between the first and second support surfaces,
wherein, dependent on an orientation of the medicine dispenser relative to a direction of gravity, the sachet when pulled through the slot is supportable by the first support surface or substantially equally supportable by the second support surface and either a first side or an opposite second side of the sachet faces away from the body.

13. The medicine dispenser of claim 12 wherein the medicine dispenser comprises a roll of the sachets of medicine, the sachets comprising labels identifying a content of the sachets, the labels being located either on a first side or on the opposite second side of the sachets, wherein a sachet of medicine has been pulled through the slot out of the body and is supported by either the first support surface or the second support surface, wherein either the first support surface or the second support surface is chosen so that the label on the sachet is facing away from the body of the dispenser and can be conveniently identified.

14. The medicine dispenser of claim 12 wherein the first and second support surfaces are located on a common plane.

15. The medicine dispenser of claim 12 wherein the first and second support surfaces are planar.

16. The medicine dispenser of claim 12 wherein the first and second support surfaces are curved.

17. The medicine dispenser of claim 12 wherein the first and second support surfaces are located immediately adjacent the slot.

18. The medicine dispenser of claim 12 wherein the first and second support surfaces have substantially the same extension and shape.

19. The medicine dispenser of claim 12 wherein the body has an axis which substantially coincides with an axis of the roll of sachets when loaded into the dispenser, wherein the slot has an axis and wherein the first and second support surfaces are symmetrical relative to a plane of symmetry defined by the axis of the body and an axis of the slot.

20. The medicine dispenser of claim 12 wherein the body comprises clips at the first and second support surfaces arranged to secure the sachet when pulled through the slot on either the first or the second support surfaces.

21. The medicine dispenser of claim 12 wherein the body is at least partially transparent.

22. The medicine dispenser of claim 12 wherein the body comprises two halves, which are separable to load a roll of the sachets and which comprise a snap-fit arranged to engage the two halves to each other such that the body is closed.

23. The medicine dispenser of claim 12 wherein the body has a base portion positioned opposite the first and second support surfaces, the base portion being arranged for mounting on the wall of a building or structure whereby the first and second support surfaces face away from the wall of the building or structure when the dispenser is mounted on the wall of the building or structure.
